(19) United States
(12) Patent Application Publication
(10) Pub. No.: US 2008/0320475 A1
(43) Pub. Date: Dec. 25, 2008

(54) Switching user mode thread context

(75) Inventors: Matthew D. Klein, Seattle, WA (US); Paul England, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/820,422

(22) Filed: Jun. 19, 2007

(51) Int. Cl. G06F 9/46

(52) U.S. Cl. 718/100

(57) ABSTRACT

Various technologies and techniques are disclosed for switching user mode thread context. A user mode portion of a thread can be switched without entering a kernel by using execution context directly based on registers. Upon receiving a request to switch a user mode part of a thread to a new thread, user mode register contexts are switched, as well as a user mode thread block by changing an appropriate register to point at the user mode thread block of the new thread. Switching is available in environments using segment registers with offsets. Each user mode thread block in a process has a descriptor in a local descriptor table. When switching a user mode thread context to a new thread, a descriptor is located for a user mode thread block of the new thread. A shadow register is updated with a descriptor base address of the new thread.

### BACKGROUND

Over time, computer hardware has become faster and more powerful. For example, computers of today can have multiple processor cores that can operate in parallel. Programmers would like for different pieces of the program to execute in parallel on these multiple processor cores to take advantage of the performance improvements that can be achieved. Thus, future programs will likely make sure of many parallel threads of execution.

Thread execution must take place on a context. Operating systems of today typically support one or more execution contexts. For example, MICROSOFT® WINDOWS® support two execution contexts, namely threads and fibers. Using threads, an application can adjust its thread state (runnable or suspended), the thread priority, etc. However, the time it takes to put one thread to sleep and start another one using this approach is relatively expensive. This is because threads must enter the operating system kernel on each thread switch. Furthermore, a user mode thread can only execute on its associated kernel thread. This makes it difficult to user threads to control application execution in parallel and/or other applications.

The second execution context is using fibers. A fiber is a lightweight execution context that can be scheduled entirely in user mode. However, fibers and many other user mode primitives cannot make use of full system services. In addition, most operating system services are built around threads as opposed to fibers, and these system services are hard to use or do not work at all when called from fibers. Thus, fibers are also difficult to use in controlling application execution in parallel and/or other operations.

### SUMMARY

Various technologies and techniques are disclosed for switching user mode thread context. A user mode portion of a thread can be switched without entering a kernel by using an execution context that is directly based on registers. The system receives a request to switch a user mode part of a thread to a new thread. The system switches a plurality of user mode register contexts. The system also switches a user mode thread block by changing an appropriate register to point at the user mode thread block of the new thread.

In one implementation, user mode thread context can be switched to a new thread in an environment that uses segment registers with offsets. For example, each user mode thread block in a process is given a descriptor in a local descriptor table. The system receives a request to switch a user mode part of a particular thread to a new thread. A descriptor is located for a user mode thread block of the new thread. A shadow register is updated with a descriptor base address of the new thread.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a user mode thread switching application of one implementation operating on the computer system of FIG. 1.

FIG. 3 is a process flow diagram for one implementation of the system of FIG. 1 illustrating the high level stages of switching the user mode part of a thread.

FIG. 4 is a process flow diagram for one implementation of the system of FIG. 1 illustrating the stages involved in switching the user mode part of a thread when the architecture uses segment register with offsets.

FIGS. 5-7 are logical diagrams that illustrate how shadow registers are updated to point to a new user mode thread block as switching occurs.

FIG. 8 is a logical diagram that illustrates how kernel thread state is updated on a kernel trap/system call.

FIG. 9 is a process flow diagram for one implementation of the system of FIG. 1 illustrating the stages involved in providing kernel fix-ups for making sure all running kernel code has consistent view of the currently active user mode thread block.

FIG. 10 is a process flow diagram for one implementation of the system of FIG. 1 that illustrates the stages involved in switching the user mode part of a thread with multiple local descriptor tables per process, with a single local descriptor table on all cores.

FIG. 11 is a process flow diagram for one implementation of the system of FIG. 1 that illustrates the stages involved in switching the user mode part of a thread with multiple local descriptor tables per process and unlinked core local descriptor table loading.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that switches user mode thread context, but the system also serves other purposes in addition to these. In one implementation, one or more of the techniques described herein can be implemented as features within an operating system program such as MICROSOFT® WINDOWS®, or from any other type of program or service that manages and/or executes threads.

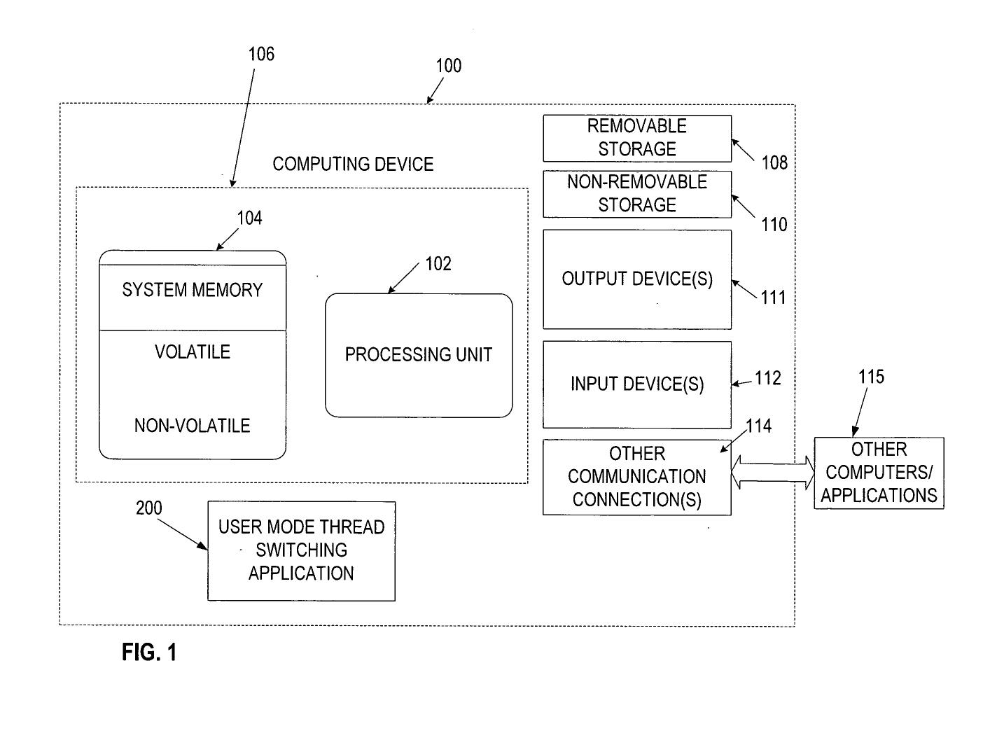

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

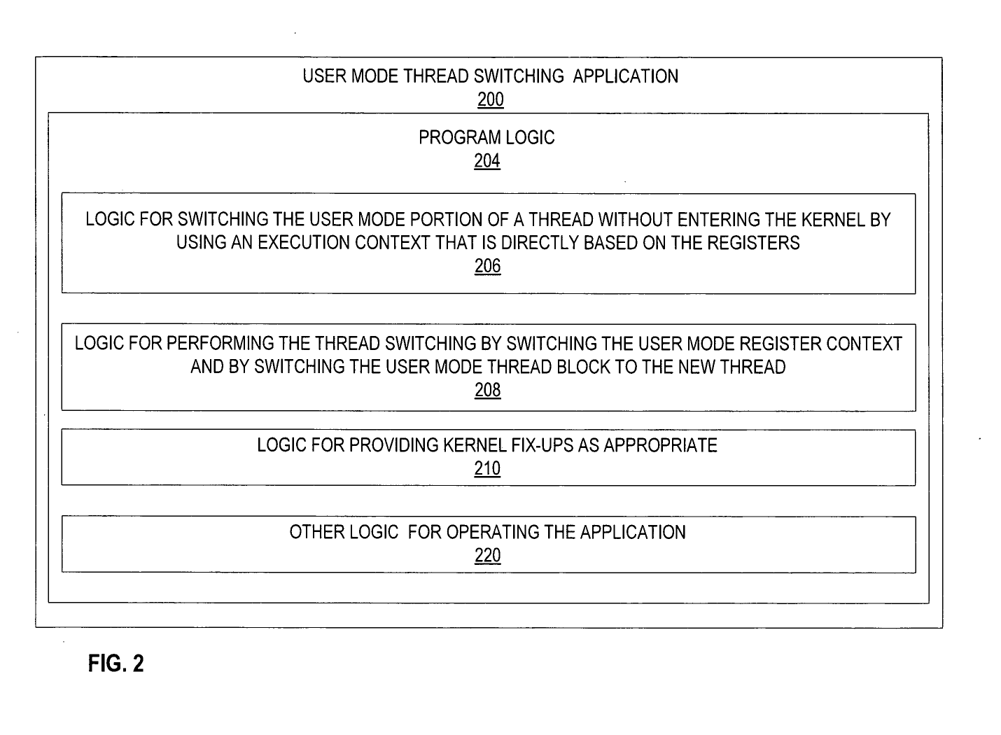

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes user mode thread switching application 200. User mode thread switching application 200 will be described in further detail in FIG. 2.

Turning now to FIG. 2 with continued reference to FIG. 1, a user mode thread switching application 200 operating on computing device 100 is illustrated. User mode thread switching application 200 is one of the application programs that reside on computing device 100. However, it will be understood that user mode thread switching application 200 can alternatively or additionally be embodied as computer-executable instructions on one or more computers and/or in different variations than shown on FIG. 1. Alternatively or additionally, one or more parts of user mode thread switching application 200 can be part of system memory 104, on other computers and/or applications 115, or other such variations as would occur to one in the computer software art.

User mode thread switching application 200 includes program logic 204, which is responsible for carrying out some or all of the techniques described herein. Program logic 204 includes logic for switching the user mode portion of a thread without entering the kernel by using an execution context that is directly based on the registers 206; logic for performing the thread switching by switching the user mode register context and by switching the user mode thread block to the new thread 208; logic for providing kernel fix-ups as appropriate 210; and other logic for operating the application 220. In one implementation, program logic 204 is operable to be called programmatically from another program, such as using a single call to a procedure in program logic 204.

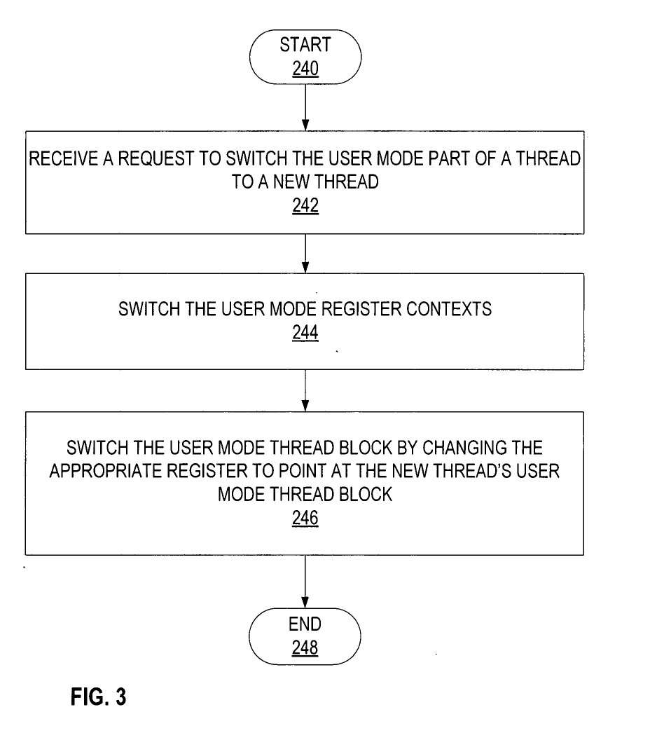

Turning now to FIGS. 3-11 with continued reference to FIGS. 1-2, the stages for implementing one or more implementations of user mode thread switching application 200 are described in further detail. FIG. 3 illustrates one implementation of the high level stages of switching the user mode part of a thread. In one form, the process of FIG. 3 is at least partially implemented in the operating logic of computing device 100. The process begins at start point 240 with the system receiving a request to switch the user mode part of a thread to a new thread (stage 242). The system switches the user mode register contexts (stage 244). The system also switches the user mode thread block by changing the appropriate register to point at the new thread's user mode thread block (stage 246). The term “user mode thread block” as used herein is meant to include user mode state that is logically associated with a user mode thread (e.g. thread local storage). The process ends at end point 248.

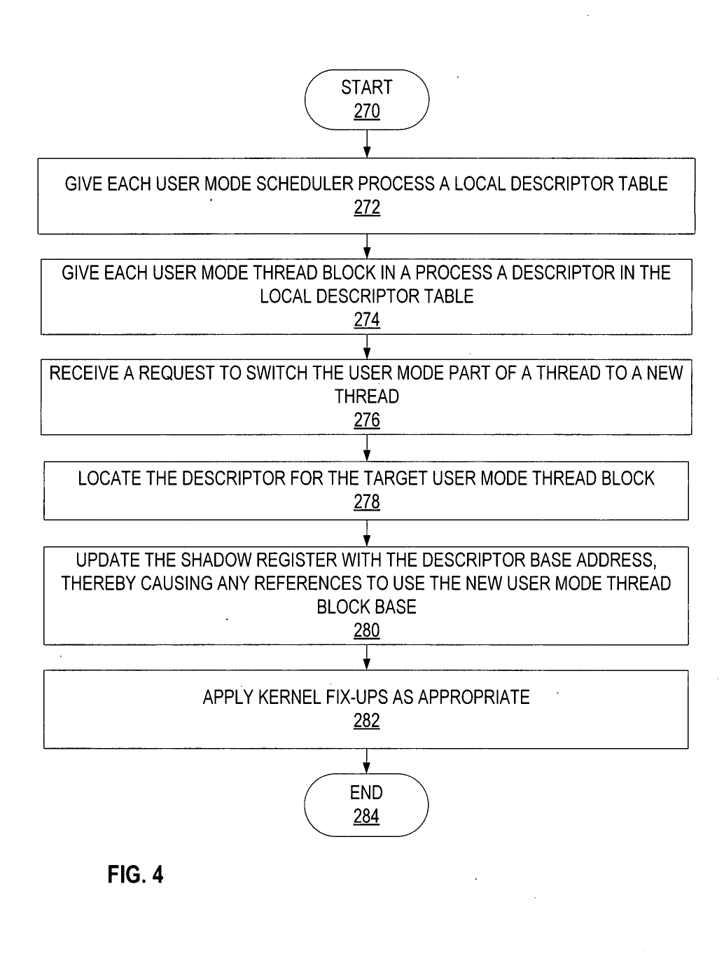

Turning now to FIGS. 4-11, the more detailed stages involved in switching a user mode part of a thread are illustrated. FIG. 4 illustrates one implementation of the stages involved in switching the user mode part of a thread when the architecture uses a segment register with offsets, such as an FS segment register used by MICROSOFT® WINDOWS®. In one form, the process of FIG. 4 is at least partially implemented in the operating logic of computing device 100. The process begins at start point 270 with giving each user mode scheduler process a local descriptor table (stage 272). Each user mode thread block in a process is given a descriptor in the local descriptor table (stage 274). The system receives a request to switch the user mode part of a thread to a new thread (stage 276). The system locates the descriptor for the target user mode thread block (stage 278). The system updates the shadow register with the descriptor base address, thereby causing any references to use the new user mode thread block base (stage 280). The system applies the kernel fix-ups ass appropriate (stage 282). The process ends at end point 284.

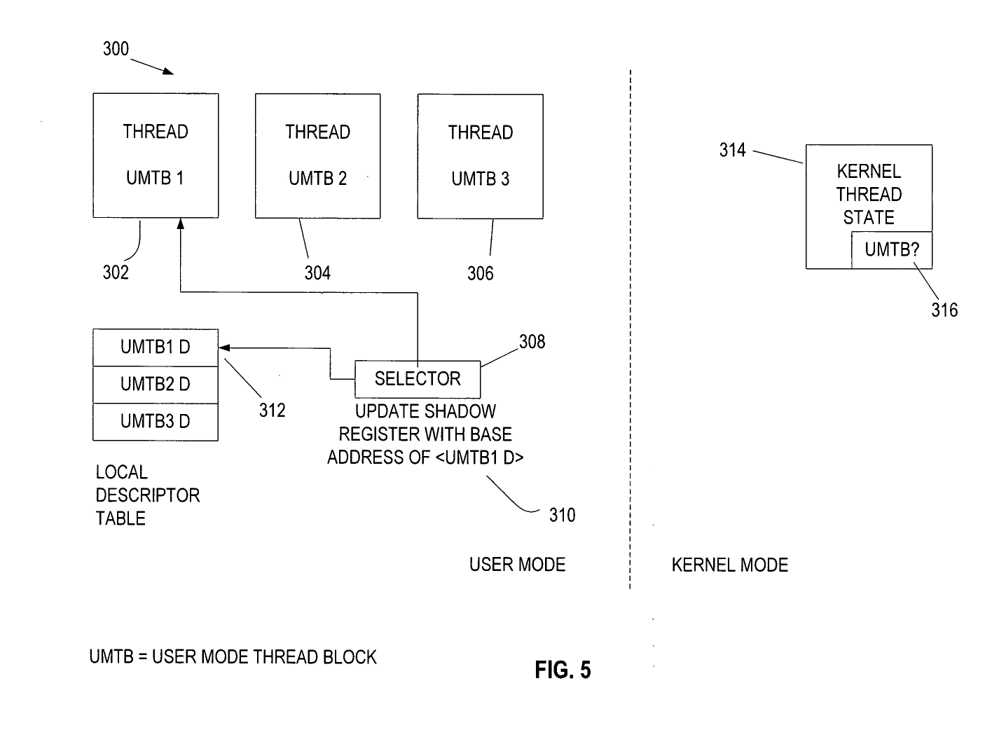

FIGS. 5-8 illustrate a hypothetical example to illustrate the user mode thread context switching in further detail. The same reference numbers are used to refer to the same items on the figures. FIGS. 5-7 are logical diagrams that illustrate how shadow registers are updated to point to a new user mode thread block as switching occurs. As shown in diagram 300 on FIG. 5, there are three different threads shown (302, 304, and 306, respectively). Each thread has a corresponding user mode thread block. The current kernel thread state 314 is also shown, which at this point does not have a user mode thread block 316. When the selector 308 receives a request to perform the switching to a different thread, the shadow register is updated with the base address of the new thread. In the example shown on FIG. 5, the first thread is selected, so instruction 310 is issued by the program which causes selector 308 to update the segment selector shadow register with the base address (contained in descriptor 312) of the user mode thread block for the first thread. The descriptor contains the base address that is read into the shadow register when the new selector for the thread is chosen.

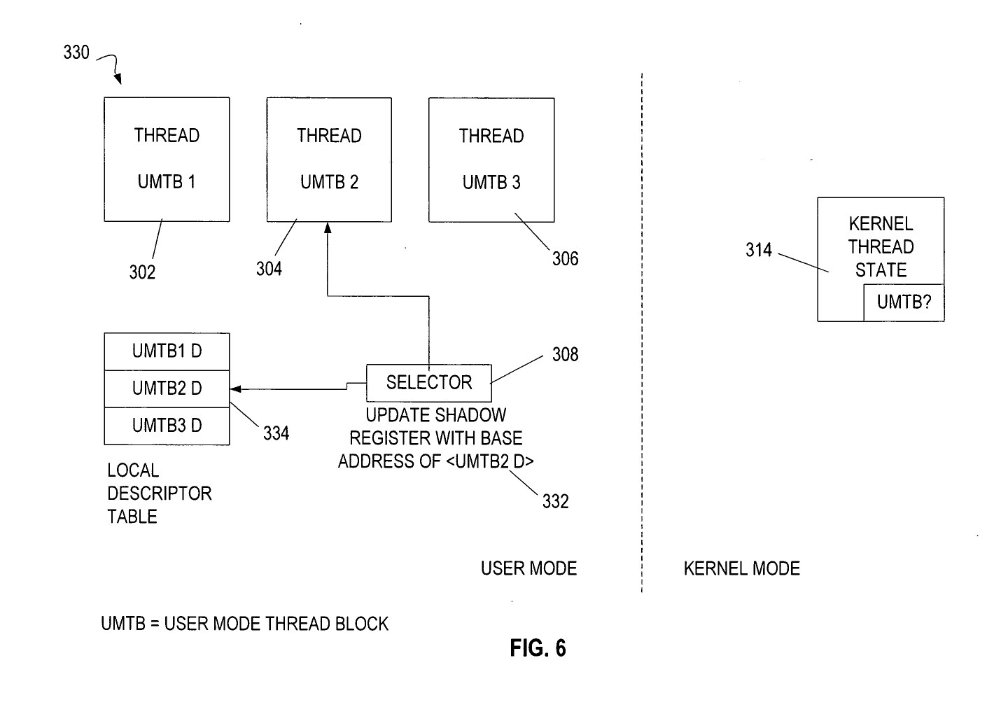

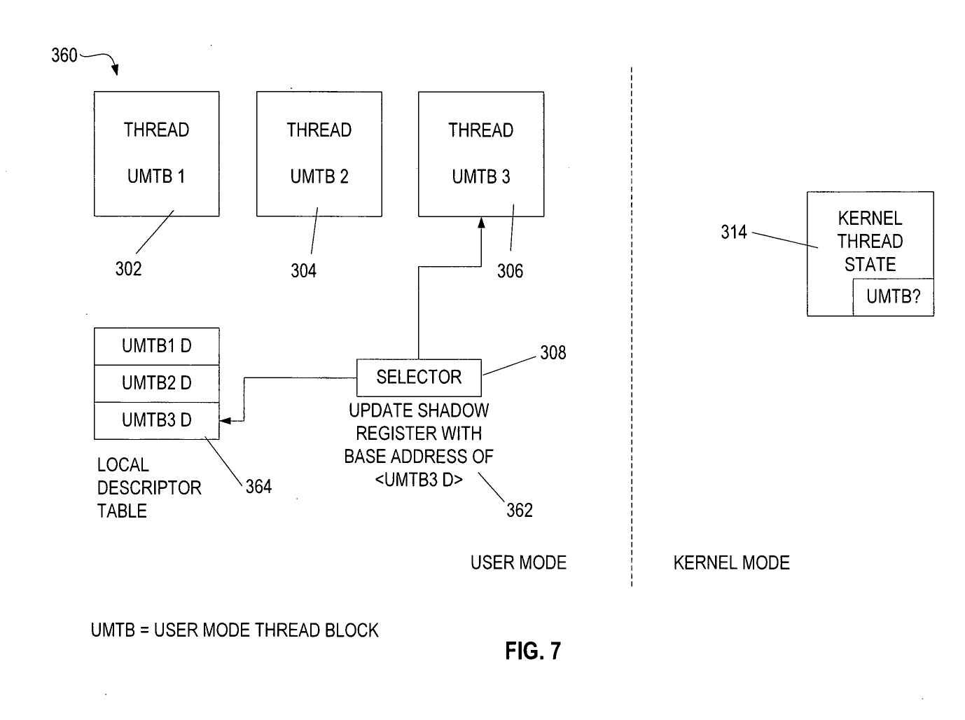

Similarly, on diagram 330 of FIGS. 6, when the second thread 304 is selected, instruction 332 is issued by the program which causes selector 308 to update the shadow register with the base address (contained in descriptor 334) of the user mode thread block for the second thread. As shown on diagram 360 of FIG. 7, when the third thread 306 is selected, the instruction 362 is issued by the program which causes selector 308 to update the shadow register with the base address (contained in descriptor 364) of the user mode thread block for the third thread. In one implementation, the register is a GS segment register, and the updates are performed by issuing a <MOV GS> instruction which updates the local descriptor table with the base address of the user mode thread block of the current thread.

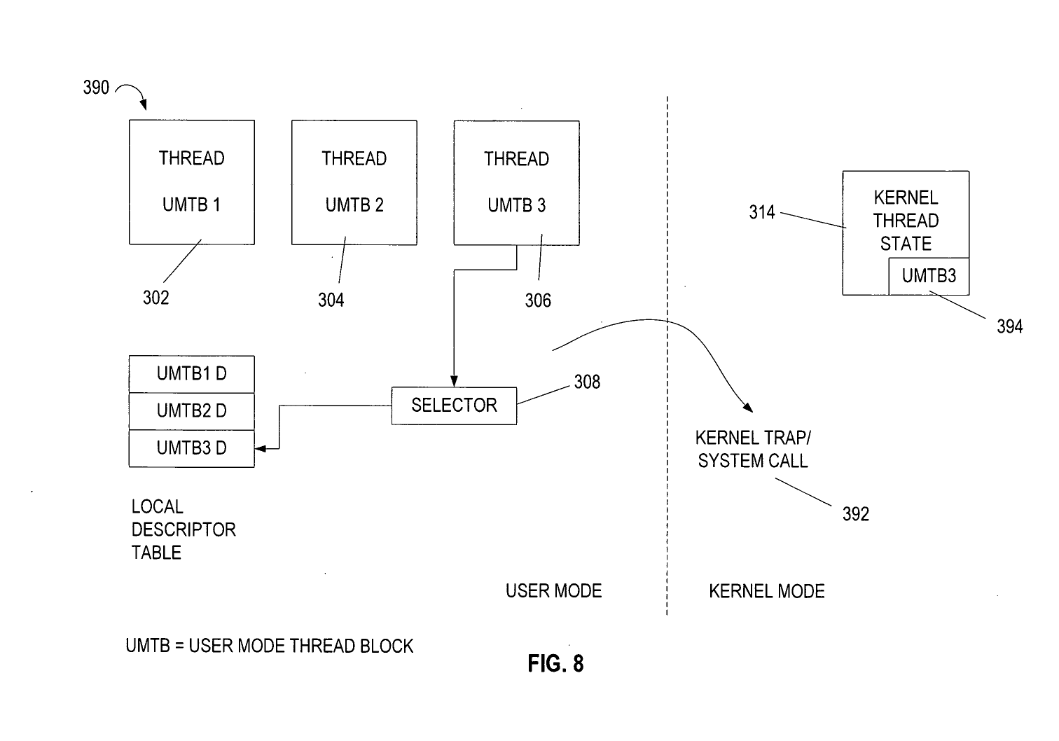

FIG. 8 is a diagram 390 of one implementation that illustrates what happens when a kernel trap/system call is encountered 392. The kernel thread state is updated with the user mode thread block value of the currently selected thread as represented in the local descriptor table. In this example, the currently selected thread is the third thread 306. Thus, the kernel thread state is updated with the user mode thread block value for the third thread 394.

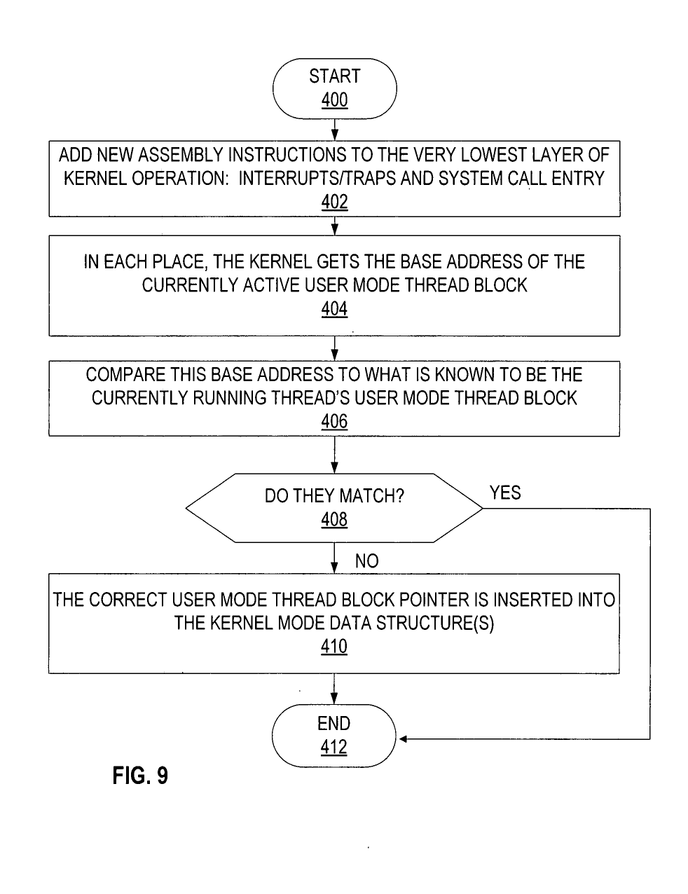

FIG. 9 illustrates one implementation of the stages involved in providing kernel fix-ups for making sure all running kernel code has consistent view of the currently active user mode thread block. In one form, the process of FIG. 9 is at least partially implemented in the operating logic of computing device 100. The process begins at start point 400 with adding new assembly instructions to the very lowest layer of kernel operation: interrupts/traps and system call entry (stage 402). In each place, the kernel gets the base address of the currently active user mode thread block (stage 404). In one implementation, this is done by reading the GS_swap MSR. This base address is compared to what is known to be the currently running thread's user mode thread block (stage 406). If they do not match (decision point 408), then the correct user mode thread block pointer is inserted into the kernel mode data structure(s) (stage 410). The process ends at end point 412.

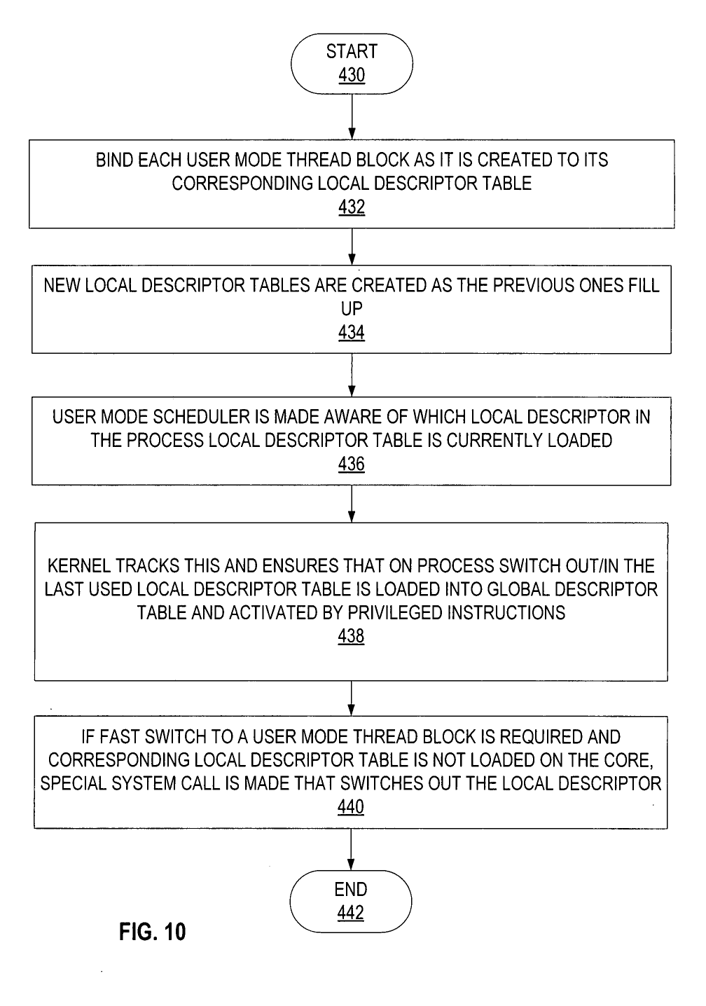

FIG. 10 illustrates one implementation of the stages involved in switching the user mode part of a thread with multiple local descriptor tables per process, with a single local descriptor table on all cores. In one form, the process of FIG. 10 is at least partially implemented in the operating logic of computing device 100. The process begins at start point 430 with the system binding each user mode thread block as it is created to its corresponding local descriptor table (stage 432). New local descriptor tables are created as the previous ones fill up (stage 434). The user mode scheduler is made aware of which local descriptor in the process local descriptor tale is currently loaded (stage 436). The kernel also tracks this and ensures that on process switch out/in, the last used local descriptor table is loaded into the global descriptor table and activated by privileged instructions (stage 438). If a fast switch to a user mode thread block is required and the corresponding local descriptor table is not loaded on the core, a special system call is made that switches out the local descriptor (stage 440). The process ends at end point 442.

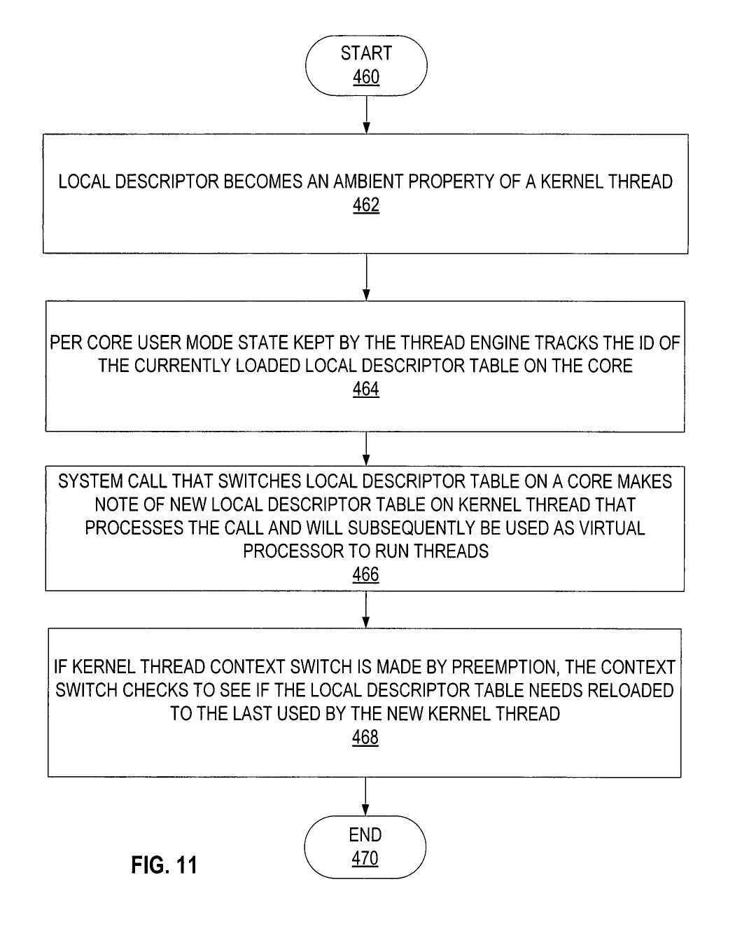

FIG. 11 illustrates one implementation of the stages involved in switching the user mode part of a thread with multiple local descriptor tables per process and unlinked core local descriptor loading. In one form, the process of FIG. 11 is at least partially implemented in the operating logic of computing device 100. The process begins at start point 460 with the local descriptor becoming an ambient property of a kernel thread (stage 462). The per core user mode state kept by the thread engine tracks the id of the currently loaded local descriptor table on the core (stage 464). The system call that switches the local descriptor table on a core makes note of the new local descriptor table on the kernel thread that processes the call and will subsequently be used as a virtual processor to run threads (stage 466). If a kernel thread context switch is made by preemption, the context switch checks to see if the local descriptor table needs reloaded to the last used by the new kernel thread, thereby ensuring consistent views of the local descriptor table for each switch operation (stage 468). The process ends at end point 470.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
switch a user mode portion of a thread without entering a kernel by using an execution context that is directly based on a plurality of registers, with the switch comprising switching a user mode register context and a user mode thread block to a new thread.

2. The computer-readable medium of claim 1, wherein each particular user mode thread block in a particular process is given a descriptor in a local descriptor table.

3. The computer-readable medium of claim 1, further having computer-executable instructions for causing a computer to perform steps comprising: provide kernel fix-ups that ensure running kernel code has a consistent view of a currently active user mode thread block.

4. The computer-readable medium of claim 3, wherein a base address of the currently active user mode thread block is compared to a saved user mode thread block address.

5. The computer-readable medium of claim 4, wherein if the base address does not match the saved user mode thread block address, then a correct user mode thread block pointer for the currently active user mode thread block is inserted into a kernel mode data structure.

6. The computer-readable medium of claim 1, wherein the switching is performed upon receiving a request to switch the user mode part of the thread to the new thread.

7. The computer-readable medium of claim 1, wherein at least one of the registers is a segment register.

8. The computer-readable medium of claim 1, wherein the segment register uses offsets.

9. A method for switching a user mode part of a thread comprising the steps of:
receiving a request to switch a user mode part of a thread to a new thread;
switching a plurality of user mode register contexts; and
switching a user mode thread block by changing an appropriate register to point at the user mode thread block of the new thread.

10. The method of claim 9, wherein the appropriate register is a segment register with offsets.

11. The method of claim 10, wherein the switching the user mode thread block stage comprises locating a descriptor for the user mode thread block of the new thread and updating a shadow register with a base address of the descriptor.

12. The method of claim 11, wherein after the switching the user mode thread block stage, any references will use the base address of the new thread.

13. The method of claim 12, wherein kernel fix-ups are applied to ensure any running kernel code has a consistent view of a currently active user mode thread block.

14. The method of claim 13, wherein a base address of the currently active user mode thread block is compared to a saved user mode thread block address.

15. The method of claim 14, wherein if the base address does not match the saved user mode thread block address, then a correct user mode thread block pointer for the currently active user mode thread block is inserted into a kernel mode data structure.

16. A computer-readable medium having computer-executable instructions for causing a computer to perform the steps recited in claim 9.

17. A method for switching a user mode part of a thread in environments using segment registers with offsets comprising the steps of:
giving each user mode thread block in a process a descriptor in a local descriptor table;
receiving a request to switch a user mode part of a particular thread to a new thread;
locating a descriptor for a user mode thread block of the new thread; and
updating a shadow register with a descriptor base address of the new thread.

18. The method of claim 17, wherein each user mode scheduler process has a separate local descriptor table.

19. The method of claim 17, wherein by updating the shadow register, any references will use the base address of the new thread.

20. A computer-readable medium having computer-executable instructions for causing a computer to perform the steps recited in claim 17.
